(19) United States
(12) Patent Application Publication
(10) Pub. No.: US 2008/0005747 A1
(43) Pub. Date: Jan. 3, 2008

(54) System and method for object state management

(76) Inventors: Klaus Meyer, Walldorf (DE); Christina Lies, Muenchen (DE); Patrick Josef Bardroff, Leimen (DE); Gregor Schilberth, Heidelberg (DE); Wasim Sadiq, Pullenvale (AU); Frank Michael Kraft, Speyer (DE); Guenter Pecht-Seibert, Muehlhausen (DE)

Correspondence Address: KENYON & KENYON LLP, 1500 K STREET N.W., WASHINGTON, DC, 20005, US

(21) Appl. No.: 11/477,787

(22) Filed: Jun. 30, 2006

(51) Int. Cl. G06F 9/46

(52) U.S. Cl. 719/316

(57) ABSTRACT

A system and method for object state management. According to an embodiment of the invention, a status management runtime environment receives a request by an application object node to determine whether an action is allowed to be performed, makes a determination, pursuant to the request, as to whether the action is allowed to be performed based at least in part on status information associated with the application object node in a status repository, and sends the determination to the application object node in response to the request.

### BACKGROUND OF THE INVENTION

Today's software systems and components are increasingly built using object technology, and the operation of these systems and components occurs through methods that are performed on and/or by objects. Since there are various ways of implementing objects in software applications, the term “object node” is used herein to refer to either an overall object or particular elements of an object (e.g., particular methods and/or attributes associated with the object).

An object node's state may be understood to include the combination of current attribute values of the object node at a certain point in time. The execution of the above-mentioned methods may change attribute values of a object node, thus leading to a new state of the object node. In many circumstances, the current state of the object or application environment may be an important factor in determining whether a particular action is allowed to be performed or not.

In order to ensure that an object node performs an action only when allowed by a certain state of the object node, developers have either coded such requirements directly into the object node itself, or relied on the programming of other unrelated object nodes—that are called by the object node to implement all or part of the action—to enforce such requirements.

For example, software that controls an assembly line in a manufacturing plant should be programmed so that a “stop” action should not be performed on the assembly line if the assembly line is currently not moving (e.g., as represented by the state of an object node representing the assembly line).

Under the first scenario described above, a programmer of the object node would directly code this requirement into the object node itself, so that when the object node receives the “stop” action request, it checks its own status attributes to make sure that the assembly line is currently moving before allowing the “stop” action to be processed. However, as software projects become larger and more complex, it can become increasingly burdensome for programmers to understand, identify and account for all constraints that are based on the state of an object node.

Under the second scenario described above, the programmer of the object node would rely on other programming to enforce this requirement. In this situation, the assembly line object node (which may or may not have its own status attributes regarding the movement of the assembly line) would receive the “stop” action request, and call another unrelated object node to implement all or part of the “stop” action. This other object node would then check its own status attributes to make sure that the assembly line is currently moving before allowing the “stop” action to be processed, but its determination would be independent of the state of the assembly line object node.

Accordingly, there is a need in the art for a system and method that allows for the management of the state of an object node in a less burdensome and more coherent manner.

### BRIEF DESCRIPTION OF THE DRAWINGS

FIG. 1 is a block diagram that depicts a system architecture in accordance with an embodiment of the present invention.

FIG. 2 is a process flow diagram that depicts an object state management process between an application object node and status management runtime in accordance with an embodiment of the present invention.

FIG. 3 is a process flow diagram that depicts an object state management process between an application object node and status management runtime in accordance with an embodiment of the present invention.

FIG. 4 is a process flow diagram that depicts an object state management process between an application object node and status management runtime in accordance with an embodiment of the present invention.

FIG. 5 is a process flow diagram that depicts an object state management process between an application object node and status management runtime in accordance with an embodiment of the present invention.

FIG. 6 is a screenshot that depicts a modeled approval status schema in accordance with an embodiment of the present invention.

FIG. 7 is a block diagram that depicts a status management model deployment in accordance with an embodiment of the present invention.

FIG. 8 is a block diagram that depicts a computing device in accordance with an embodiment of the present invention.

### DETAILED DESCRIPTION

Embodiments of the present invention allow for a less burdensome and more coherent state management of an object node by providing a separate status management runtime that tracks status information associated with individual object nodes in a status repository, and makes determinations, on behalf of the object nodes, as to whether actions are allowed to be performed based at least in part on the status information associated with the object nodes in the status repository.

As a result, object node programmers need only to code calls to the status management runtime to make sure an action is allowed to be performed, instead of having to understand, identify and account for all constraints that are based on the state of an object node. Additionally, by having object node status information represented in the status repository, the status management runtime is able to use this information in a coherent manner so as to not make any determination independent of an object node's state.

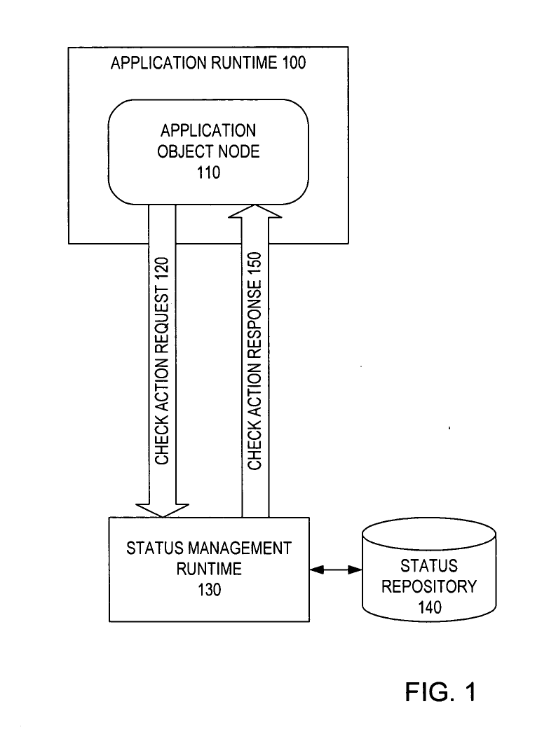

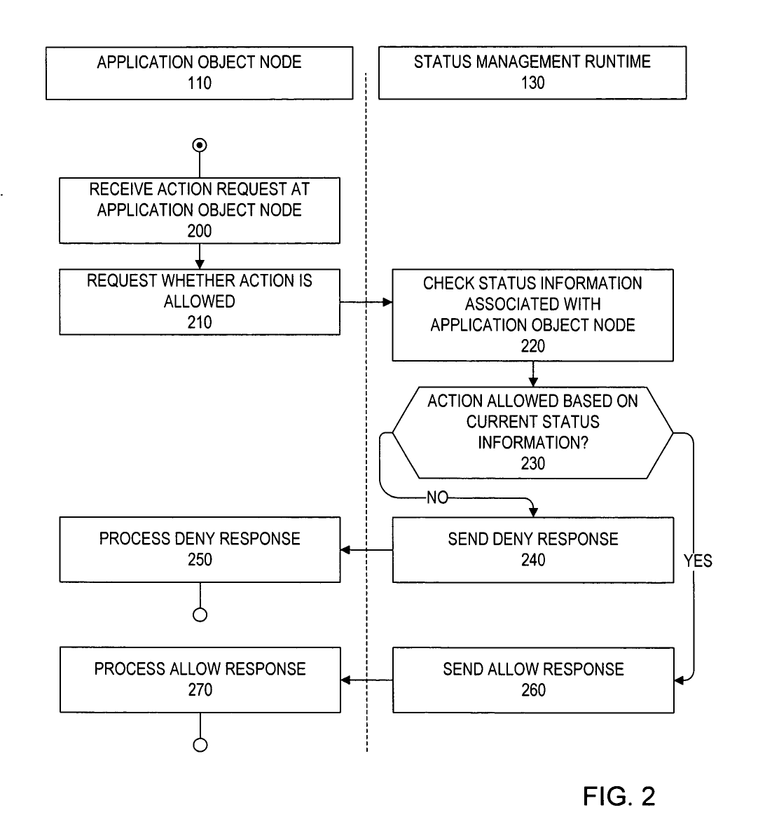

As shown in FIGS. 1 and 2, when an application object node (110) in an application runtime environment (100) receives a request to perform an action (step 200), it sends a request (120) to a status management runtime (130) to determine whether the action is allowed to be performed (step 210). The status management runtime (130) then checks a status repository (140) to determine whether the status information associated with the application object node (110) permits the action to be performed (steps 220 and 230).

If the outcome of the determination specifies that the action is not allowed, then the status management runtime (130) sends a response (150) to the application object node (110) indicating that the action is not allowed to be performed (step 240), and the application object node (110) processes that negative response (step 250). On the other hand, if the outcome of the determination specifies that the action is allowed, then the status management runtime (130) sends a response (150) to the application object node (110) indicating that the action is allowed to be performed (step 260), and the application object node (110) processes that positive response (step 270).

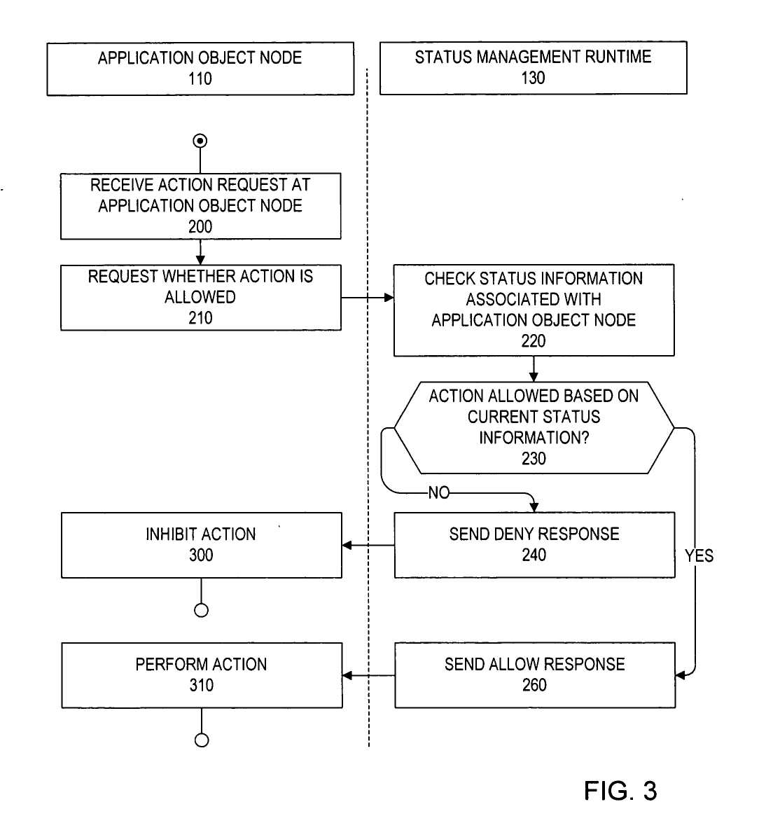

FIG. 3 depicts an embodiment of the invention in which the application object node (110) processes the response (150) by inhibiting or performing the action. The application object node (110) processes a negative response (step 250) by inhibiting the action from being performed (step 300). One example of inhibiting the action is to send an error message to the source that requested the action to be performed; another is to simply ignore the action request and continue on. The application object node (110) processes a positive response (step 270) by performing the action.

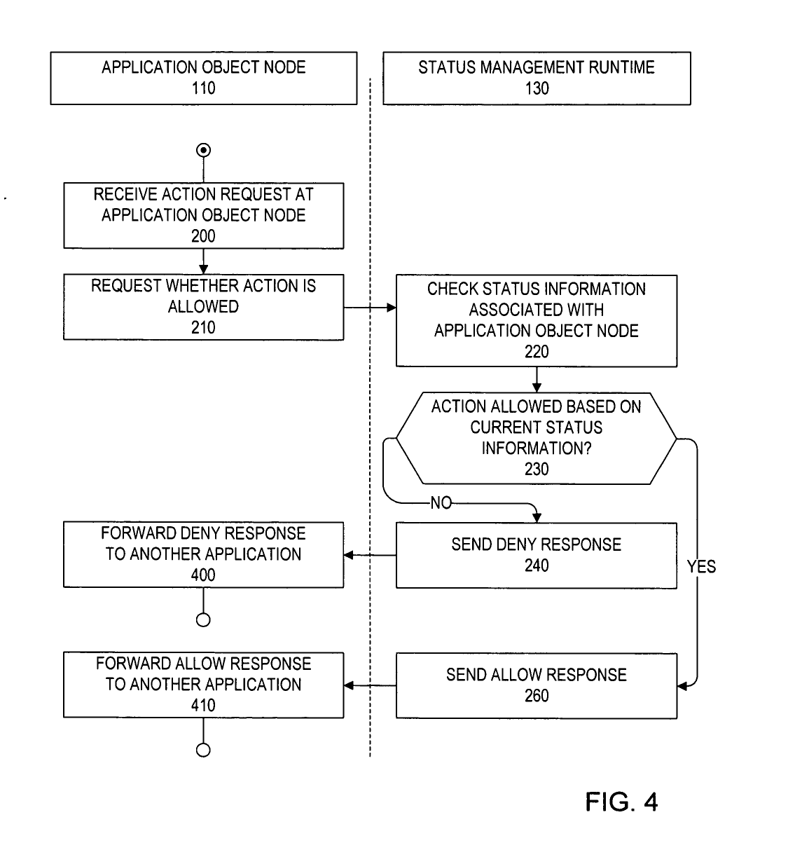

FIG. 4 depicts an embodiment of the invention in which the application object node (110) processes the response (150) by forwarding it to another application for processing. The application object node (110) processes a negative response (step 250) by forwarding it to another application (step 400), while the application object node (110) processes a positive response (step 270) by forwarding it to another application (step 410). This may occur, for example, when a client application hosts a user interface, and a user clicks on a certain button to implement an action. The client application sends the request to perform the action to the application object node (110), which queries the status management runtime (130) for a determination and subsequently returns the positive or negative response to the client application for further processing (e.g., allowing or denying the user's request).

In another embodiment, a client application may send a list of requested actions to the application object node (110), which queries the status management runtime (130) for determinations of the requested actions and subsequently returns the positive and/or negative responses to the client application for further processing.

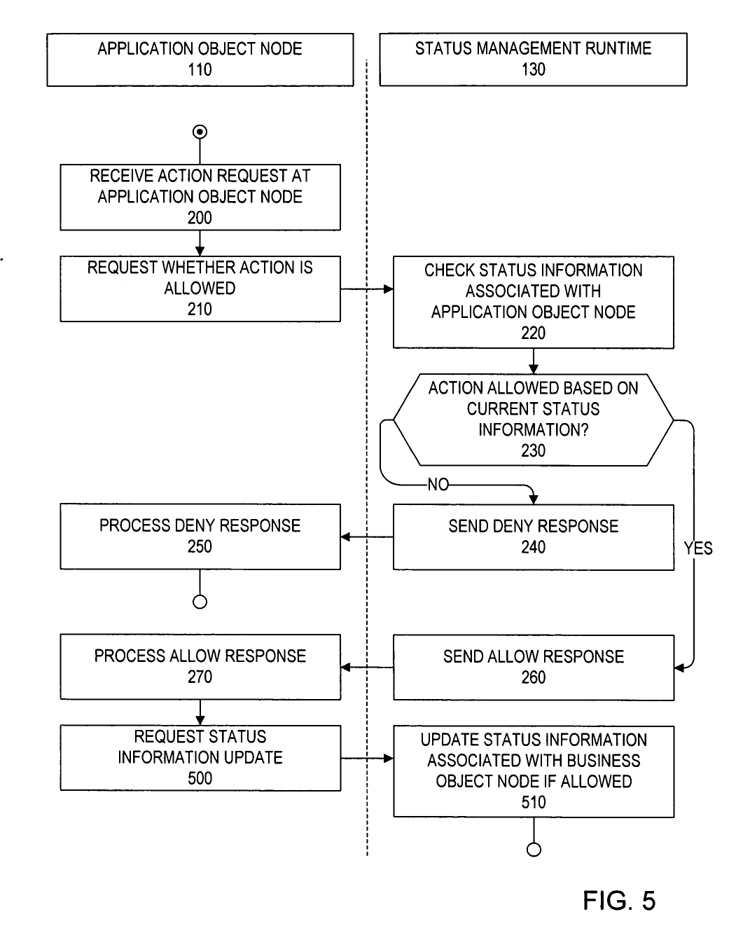

FIG. 5 depicts an embodiment of the invention in which the application object node (110), subsequent to processing a positive response (step 270) which changes the state of the node, sends a request (step 500) to the status management runtime (130) to update the status information associated with the application object node (110) in the status repository (140) to reflect the change in the node's state. In response to the request, the status management runtime (130) makes the requested update (step 510) if it determines that the status information associated with the update request is allowed to be updated. Otherwise, the status management runtime (130) provides an error message to the application object node (110), which processes the error message by, for example, forwarding the error message to another application, providing the status management runtime (130) with a corrective update request, or rolling back the action that was allowed to be performed in step 230.

The status information associated with the application object node (110) in the status repository (140) may include one or more status attribute values associated with the application object node (110) and one or more constraints identifying what actions may be allowed to be performed based at least in part on the one or more status attribute values. The status information may also include one or more constraints identifying what status attribute values may be allowed to be set following the performance of an action, in addition to one or more constraints identifying what status attribute values may be changed based on a change in one or more other status attribute values. Status attribute value information associated with an application object node 110 may be previously stored in the status repository 140 or passed by the application object node 110 along with the check action request (120).

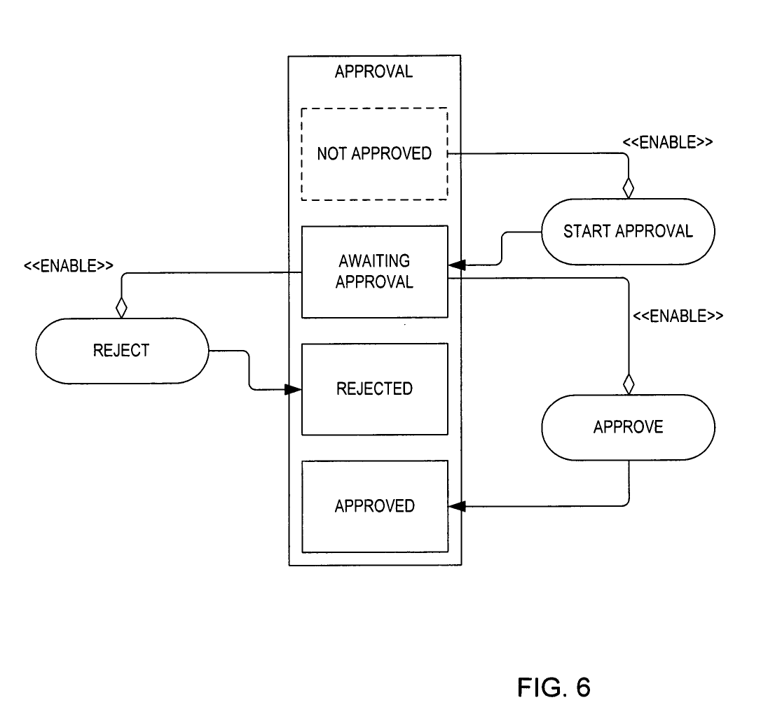

The status information may also be based on a status schema derived from a design-time model, as shown in the embodiment of FIG. 6. The status schema may include all relevant status variables and associated status values, actions and conditions modeled for given object nodes and stored in the status repository (140). For example, at design time the status schema, which creates relations between an object's state and actions, may define constraints for the actions by describing which actions are allowed for which status values, and define which status values will be set after the completion of the action. At runtime the status schema instance may be loaded from the status repository (140) by the status management runtime (130) with the current values of the status variables.

FIG. 6 depicts, for example, an example of an Approval status schema. It includes a single status variable <Approval> with four possible status values (<<Not Approved>>, <<Awaiting Approval>>, <<Rejected>> and <<Approved>>) and three actions ([Start Approval], [Reject] and [Approve]). The model may be instantiated with the initial value <<Not Approved>> as indicated by the dotted-line border. Approval of the action [Start Approval], for example, causes the status value <<Awaiting Approval>> to be set, which is a pre-condition of the [Reject] and [Approve] actions (i.e., a [Reject] or [Approve] action is not allowed unless the <<Awaiting Approval>> value is currently set).

The modeled status variables and their status values represent the state of the object node. The status values represent the possible values a status variable is allowed to take up, while the status variable lists all possible allowed status values. At runtime the status variable then specifies information about the currently valid value. The modeled actions represent the methods that may be performed on or by the object node. Whether they are allowed or not is dependent on the currently set status value associated with the object node's state. The modeled preconditions are identified by the connections (edges) from status values to actions, and they represent the status value constraints allowing or permitting the actions. The modeled transitions are identified by the edges that come out of an action and connect to a resulting status value, and they represent constraints allowing or permitting the setting of a status value following the performance of an action (for example, as triggered by the updating step 510). The model may also identify edges drawn from one status value of one variable to another status value of another variable (not shown), indicating that one status change directly triggers another one. The status management runtime (130) may adjust such other status information in the status repository (140) during the application runtime.

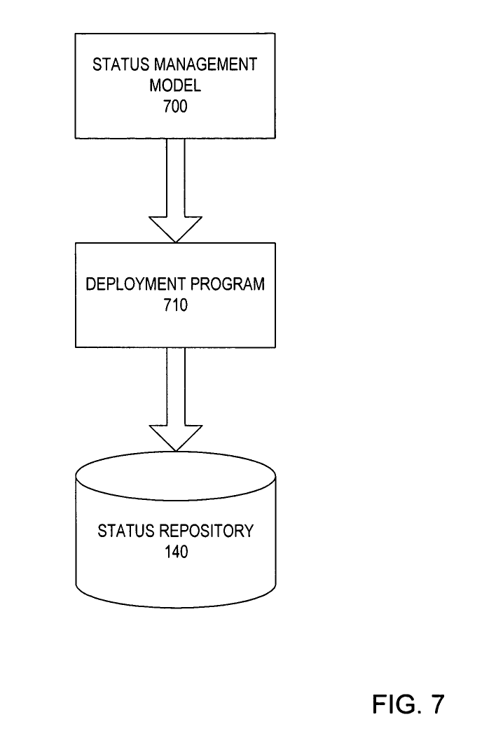

FIG. 7 depicts the process of a deployment program (710) reading and interpreting status schemas from a status management model (700) and persisting them into a status repository (140), which may comprise several database tables, for example. Pursuant to this flexible architecture, therefore, if the model is changed and deployed into the status repository (140) the next time an object node requests the usage of the model, the new changed model is utilized.

Additionally, the status management runtime 130 may operate in a simulation mode. Instead of the status management runtime 130 communicating with an application object node 110 in an application runtime 100, the application object node 110 may be associated with a user interface application deployed in the status management runtime 130. In this manner, the operation of the status management runtime 130 in connection with a particular application object node 110 may be tested prior to deployment of the application object node 110 in an actual application runtime 100.

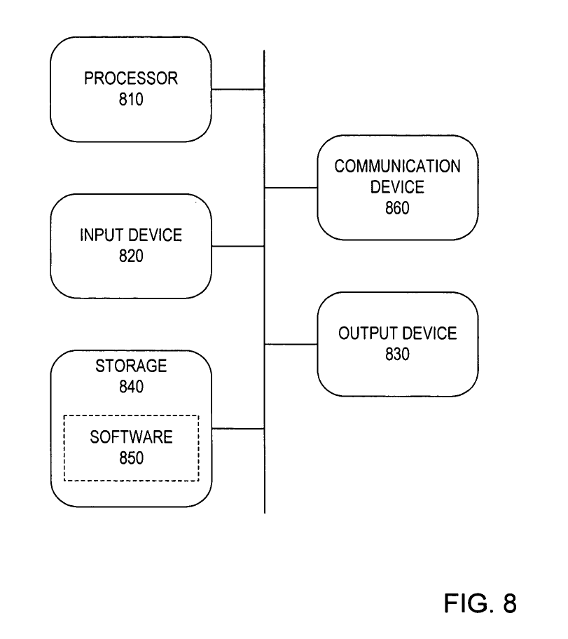

FIG. 8 illustrates the components of a basic computing device in accordance with an embodiment of the present invention, which may include application runtime environment 100 and status management runtime 130. The computing device may be a workstation, server, personal computer, handheld computing device, or any other type of microprocessor-based device. The computing device may include one or more of processor 810, input device 820, output device 830, storage 840, and communication device 860.

Input device 820 may include a keyboard, mouse, pen-operated touch screen or monitor, voice-recognition device, or any other device that provides input. Output device 830 may include a monitor, printer, disk drive, speakers, or any other device that provides output.

Storage 840 may include volatile and nonvolatile data storage, including one or more electrical, magnetic or optical memories such as a RAM, cache, hard drive, CD-ROM drive, tape drive or removable storage disk. Communication device 860 may include a modem, network interface card, or any other device capable of transmitting and receiving signals over a network. The components of the computing device may be connected in any manner, such as via electrical bus or wirelessly.

Software 850, which may be stored in storage 840 and executed by processor 810, may include, for example, the application programming that embodies the functionality of the present invention (e.g., as embodied in application runtime environment 100 and status management runtime 130). Software 850 may include a combination of client applications and enterprise servers such as an application server and a database server.

Communications in connection with the present invention may occur over any type of interconnected communication system/network, which may implement any communications protocol, which may be secured by any security protocol. Corresponding network links may include telephone lines, DSL, cable networks, T1 or T3 lines, wireless network connections, or any other arrangement that implements the transmission and reception of network signals.

The computing device may implement any operating system, such as Windows or UNIX. Software 850 may be written in any programming language, such as ABAP, C, C++, Java or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention.

For example, software modules that implement the present invention such as application runtime environment 100 and status management runtime 130 may comprise several discrete modules that together still provide the same functionality, data specified in the illustrated status repository may be spread over several databases and/or systems, and the flow diagram of FIGS. 2-5 may encompass combined steps or several intermediate steps that do not detract from the higher level functionality described therein.

What is claimed is:

1. A system for object state management, comprising:
an application object node deployed in an application runtime environment;
a status management runtime environment communicatively linked to the application object node; and
a status repository communicatively linked to the status management runtime environment, the status repository including status information associated with the application object node, wherein
the application object node receives a request to process an action,
the application object node, pursuant to the process action request, sends a request to the status management runtime environment to determine whether the action is allowed to be performed,
the status management runtime environment makes a determination, pursuant to the determination request, as to whether the action is allowed to be performed based at least in part on the status information associated with the application object node in the status repository, and
the status management runtime environment sends the determination to the application object node in response to the determination request.

2. The system of claim 1, wherein the status information includes one or more status attribute values associated with the application object node and one or more constraints identifying what actions may be allowed to be performed based at least in part on the one or more status attribute values.

3. The system of claim 1, wherein the status information is based on a status schema derived from a model.

4. The system of claim 1, wherein the application object node, upon receiving the determination, inhibits the action if the determination indicates that the action is not allowed to be performed.

5. The system of claim 1, wherein the application object node, upon receiving the determination, performs the action if the determination indicates that the action is allowed to be performed.

6. The system of claim 1, wherein the application object node, upon receiving the determination, forwards the determination to another application for processing.

7. The system of claim 1, wherein the application object node, subsequent to receiving the determination, sends a request to the status management runtime environment to update the status information associated with the application object node in the status repository.

8. The system of claim 7, wherein the status management runtime environment, in response to the update request, updates the status information associated with the application object node in the status repository.

9. The system of claim 1, wherein the status management runtime environment adjusts other status information in the status repository based on changes made to the status information associated with the application object node.

10. A method for object state management, comprising:
receiving at a status management runtime environment a request by an application object node to determine whether an action is allowed to be performed;
making a determination at the status management runtime environment, pursuant to the request, as to whether the action is allowed to be performed based at least in part on status information associated with the application object node in a status repository; and
sending by the status management runtime environment the determination to the application object node in response to the request.

11. The method of claim 10, wherein the application object node is deployed in an application runtime environment distinct from the status management runtime environment.

12. The method of claim 10, wherein the application object node is associated with a user interface application deployed in the status management runtime environment.

13. The method of claim 10, wherein the status information includes one or more status attribute values associated with the application object node and one or more constraints identifying what actions may be allowed to be performed based at least in part on the one or more status attribute values.

14. The method of claim 13, wherein at least a portion of the status information is provided in the request by the application object node.

15. The method of claim 10, wherein the application object node, subsequent to receiving the determination, sends a request to the status management runtime environment to update the status information associated with the application object node in the status repository.

16. The method of claim 15, wherein the status management runtime environment, in response to the update request, updates the status information associated with the application object node in the status repository if the status management runtime environment determines that the status information associated with the update request is allowed to be updated.

17. The method of claim 15, wherein the status management runtime environment, in response to the update request, provides an error message to the application object node if the status management runtime environment determines that the status information associated with the update request is not allowed to be updated.

18. The method of claim 17, wherein the status management runtime environment processes the error message.

19. An apparatus for object state management, comprising:
means for receiving at a status management runtime environment a request by an application object node to determine whether an action is allowed to be performed;
means for making a determination at the status management runtime environment, pursuant to the request, as to whether the action is allowed to be performed based at least in part on status information associated with the application object node in a status repository; and
means for sending by the status management runtime environment the determination to the application object node in response to the request.
